(19) United States
(12) Patent Application Publication
(10) Pub. No.: US 2009/0064174 A1
(43) Pub. Date: Mar. 5, 2009

(54) CONFIGURABLE DYNAMIC AUDIT LOGGER

(75) Inventors: Laura M.L. Chan, Ontario (CA); Abelard C-M Chow, Markham (CA); Tinny M.C. Ng, Toronto (CA); Neil Santos, Mississauga (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/845,853

(22) Filed: Aug. 28, 2007

(51) Int. Cl. G06F 9/44

(52) U.S. Cl. 719/313

(57) ABSTRACT

Exemplary embodiments of the present invention comprise a method for the real-time configuration of requirements for the auditing of message log data. The method comprises identifying at least one message entry field within a message, wherein the message entry field comprises message information, creating a message entry map, the message entry map comprising instructions for the mapping of information from the identified message entry fields comprised within a message to a target audit record message, and utilizing the message entry map to configure a mapping engine to map the information from the identified message entry fields comprised within a message to a target audit record message. The method further comprises retrieving a message from an Enterprise Service Bus, extracting the information from the identified message entry fields comprised within the message, and writing the extracted message information to an audit record message.

### BACKGROUND OF THE INVENTION

1. Field of the Invention

This invention relates to the auditing of message log data, and particularly to the field of implementing a configurable data audit logger.

2. Description of Background

Before our invention organizations were commonly faced with the task of auditing and reporting of heterogeneous message log data within their environments. For example, data may be required to be audited in response to regulatory requirements, responding to security threats, preserving the chain of custody for forensic purposes, as well as capturing baseline information about corporate security practices and flow pattern of messaging traffic.

Ideally an application developer should not need to modify any existing mediation flows during development time for enabling the capability to audit data. Analyst should be able to dynamically configure tile fields that are desired to be logged in an audit trail. However, this is not the case with the existing enterprise service bus products. This capability has to be implemented statically within the flow of the enterprise service bus by developers during development of the mediation flows in the enterprise service bus.

### SUMMARY OF THE INVENTION

The shortcomings of the prior art are overcome and additional advantages are provided through the provision of a method for the real-time configuration of requirements for the auditing of message log data. The method comprises identifying at least one message entry field within a message, wherein the message entry field comprises message information, creating a message entry map, the message entry map comprising instructions for the mapping of information from the identified message entry fields comprised within a message to a target audit record message, and utilizing the message entry map to configure a mapping engine to map the information from the identified message entry fields comprised within a message to a target audit record message. The method further comprises retrieving a message from an Enterprise Service Bus, extracting the information from the identified message entry fields comprised within the message, and writing the extracted message information to an audit record message.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a configurable message mapping system in accordance with exemplary embodiments of the present invention.

FIG. 2A illustrates an example of a message retrieved from an enterprise service bus in accordance with exemplary embodiments of the present invention.

FIG. 2B illustrates an example of a Common Base Event Message created in accordance with exemplary embodiments of the present invention.

FIG. 2C illustrates an example of a map entry created in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention allow for the dynamic configuration of fields that are to be logged at an enterprise service bus (ESB) for audit purposes during runtime, thus allowing for the ESB to be leveraged as a central information collection point. This aspect is accomplished by the provision of a dynamically configurable audit logger that is pluggable into the ESB. The present system is flexible enough to support different ESB implementations with one set of message entry map and mapping engine. It provides an ability to enable and configure audit logging dynamically at runtime across a wide range of different ESB products using just one mapping artifact and engine.

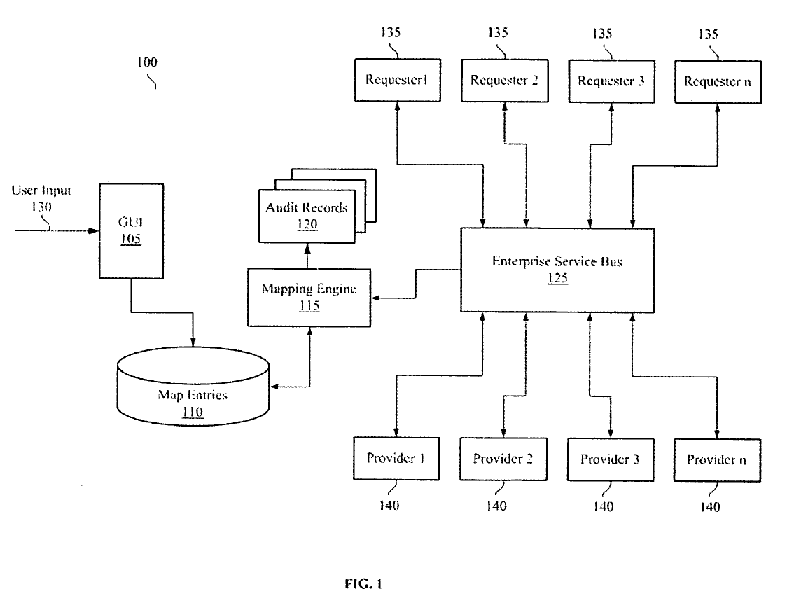

Turning now to the drawings in greater detail, it will be seen that in FIG. 1 there is system for the dynamically configurable audit logging system 100. A GUI 105 is presented to a system user at a display device (not shown). The GUI presents the user with the means to dynamically configure the fields within a message that are to be logged for predetermined auditing purposes. The user inputs 130 these configuration requirements to the system via the GUI 105. As a result of the user input instructions a message entry map is created, the message entry map comprises instructions for the mapping of message information from identified message entry fields comprised within a message to a target audit record message (e.g., an audit record message such as a Common Base Event message). Thereafter, the user prescribed configuration requirements are saved as a message map at a message entry mapping database 110.

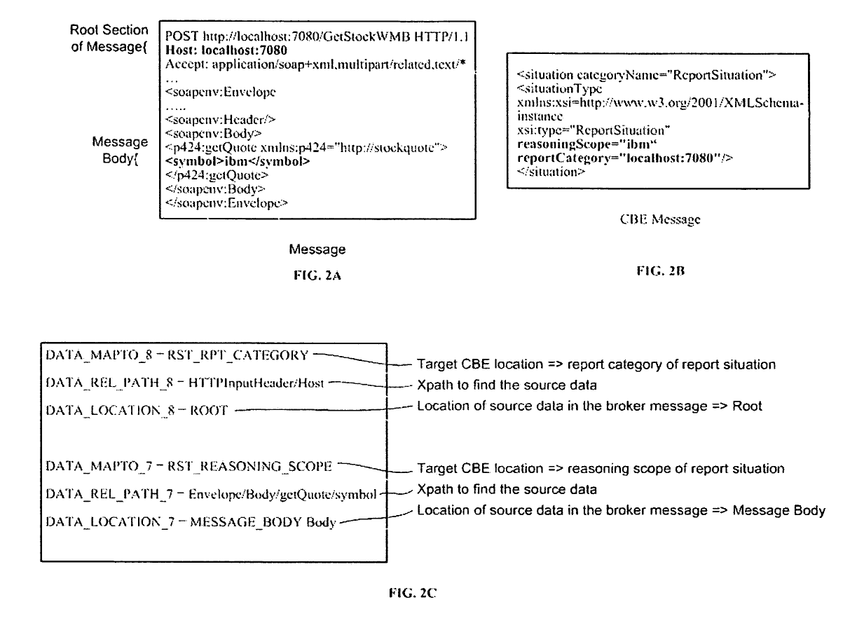

In operation, the message entry map is utilized to configure a mapping engine 115 to map the information from the identified message entry fields comprised within a message to an audit record message. The ESB 125 managing a plurality of communication flows between a plurality of service requesters 135 and service providers 140. The mapping engine 115 retrieves a message from the ESB 125 (FIG. 2A) and in accordance with the directives prescribed by the message mapping entry extracts the information from the identified message entry fields (FIG. 2C) comprised within the message and writes the extracted message information to a Common Base Event message (FIG. 2B). The audit record message is thereafter saved as the audit records 120.

As shown in FIG. 2C, the mapping engine 115 reads the message mapping entries as specified by the message map and writes the message entries into a Common Base Event message (FIG. 2B) audit record. FIG. 2C shows the target Common Base Event message field location, the path to identify the source message data and the location of the source data within the original message. Within exemplary embodiments of the present invention at a minimum two levels of message mapping entries to a Common Base Event message should be supported. As mentioned above, the mapping engine 115 presented within the exemplary embodiments can be integrated with a pre-existing ESB. As such, the mapping engine 115 provides the capability to dynamically enable and configure audit logging at runtime across a wide range of different ESB products with the use of a single mapping artifact and engine.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the real-time configuration of requirements for the auditing of message log data, the method comprising:
identifying at least one message entry field within a message, wherein the message entry field comprises message information;
creating a message entry map, the message entry map comprising instructions for the mapping of information from the identified message entry fields comprised within a message to a target audit record message;
utilizing the message entry map to configure a mapping engine to map the information from the identified message entry fields comprised within a message to a target audit record message;
retrieving a message from an Enterprise Service Bus;
extracting the information from the identified message entry fields comprised within the message; and
writing the extracted message information to an audit record message.

2. The method of claim 1, wherein the message entry map is created using information received from a business user via a GUI.

3. The method of claim 1, wherein the mapping engine can be integrated with a pre-existing Enterprise Service Bus.

4. A computer program product that includes a computer readable medium useable by a processor, the medium having stored thereon a sequence of instructions which, when executed by the processor, causes the processor to audit message information received from an Enterprise Service Bus by:
receiving information identifying at least one message entry field within a message, wherein the message entry field comprises message information;
creating a message entry map, the message entry map comprising instructions for the mapping of information from the identified message entry fields comprised within a message to a target audit record message;
utilizing the message entry map to configure a mapping engine to map the information from the identified message entry fields comprised within a message to a target audit record message;
retrieving a message from an Enterprise Service Bus;
extracting the information from the identified message entry fields comprised within the message; and
writing the extracted message information to a audit record message.

5. The computer program product of claim 1, wherein the message entry map is created using information received from a system user via a GUI.

6. The computer program product of claim 1, wherein the mapping engine can be integrated with a pre-existing Enterprise Service Bus.
